(19) United States
(12) Patent Application Publication
(10) Pub. No.: US 2009/0192759 A1
(43) Pub. Date: Jul. 30, 2009

(54) FOOTWEAR BASED INFORMATION DISPLAY CASE DESIGN

(75) Inventor: Paul Wedge, Toronto (CA)

Correspondence Address: DENNISON ASSOCIATES, 133 RICHMOND STREET WEST, SUITE 301, TORONTO, ON, M5H 2L7, CA

(73) Assignee: Morrison Strain International Corp., Toronto (CA)

(21) Appl. No.: 12/253,905

(22) Filed: Oct. 17, 2008

Related U.S. Application Data
(63) Continuation-in-part of application No. 29/302,793, filed on Jan. 24, 2008.

(51) Int. Cl. G01C 22/00

(52) U.S. Cl. 702/160

(57) ABSTRACT

The present invention is directed to an information display unit containing a power source, a program for gathering and calculating information and a display means on an upper surface for displaying the information. A side or lower surface of the information display unit is provided with a means for releasably attaching the display case to a shoe. Preferably, the information gathered and calculated by the program and displayed on the display means includes one or more of the distance traversed, calories burned, the amount of steps taken, speed traverse, altitude attained or geographical location.

### CROSS REFERENCE TO RELATED APPLICATIONS

This application is a continuation of application Ser. No. 29/302,793, filed Jan. 24, 2008, which remains pending.

### FIELD OF THE INVENTION

The present invention is directed to a footwear based information display case and in particular an information display case which attaches to the laces or other fasteners of a shoe or boot.

### BACKGROUND OF THE INVENTION

The use of information display cases such as for example pedometers used by walkers and runners are known in the art. Many such pedometers are belt mounted and operate by counting the steps the person takes. Based upon the average stride length, the total distance covered by the walker or runner is calculated and displayed. Recently, a number of shoe based designs have been developed which provide for a more accurate count of the strides. Examples of such designs for mounting to the shoe are shown for example in U.S. Pat. No. 4,019,030 issued to Tamiz on Apr. 19, 1977, Canadian Patent 1,208,432 issued to the present applicant on Jul. 29, 1986 and PCT Application WO 88/04768 by Scientific Applied Research published on Jun. 30, 1988.

The design of Tamiz shown in U.S. Pat. No. 4,019,030 adds a significant amount of weight to the shoe, incorporates a number of moving parts prone to wear and breakdown and requires that apertures be formed in the bottom of the shoe which will result in the ingress of moisture and dirt into the shoe when the protective shields wear out. The designs of my previous Canadian Patent as well as that of WO 88/04768 both overcome some of the problems by utilizing a signal generating means placed in the sloe of the shoe connected to a display device on the upper of the shoe. While these designs do overcome some of the problems described above, they do require multiple parts which must be interconnected by wires to operate. The wires can interfere with the operation of the shoe and are also susceptible to breakage rendering the unit inoperative. In addition, the unit must either be permanently attached to the shoe or else the user has to properly place each of the individual components in the shoe prior to use. If the unit is permanently attached to the shoe it can not be moved from one shoe to another.

There thus remains a need for an information display case which overcomes the problems of the prior art, and in particular is easy to use with multiple shoes.

### SUMMARY OF THE INVENTION

The present invention is directed to an information display unit containing a power source, a program for gathering and calculating information and a display means on an upper surface for displaying the information. A side or lower surface of the information display unit is provided with a means for releasably attaching the display case to a shoe.

In an aspect of the invention the means for releasably attaching the information display unit to a shoe is an opening provided at the corners of the information display unit through which shoelaces of the shoe may pass to releasably attach the information display unit to a shoe.

In another aspect of the invention the means for releasably attaching the information display unit to a shoe is one or more U shaped protrusions on the lower surface of the information display unit through which shoelaces or other fastening devices of the shoe may pass to releasably attach the display case to a shoe.

In yet another aspect of the invention, the information gathered and calculated by the program and displayed on the display means includes one or more of the distance traversed, calories burned, the amount of steps taken, speed traverse, altitude attained or geographical location.

In a further aspect of the invention, the display means is one or more of a visual display means or an audible display means.

In another aspect of the invention the display means is a liquid crystal visual display.

### BRIEF DESCRIPTION OF THE DRAWINGS

Preferred embodiments of the present invention are illustrated in the attached drawings wherein:

FIG. 1 is a perspective view of a preferred embodiment of the information display case of the present invention attached to a running shoe;

FIG. 2 is a side elevation view of the information display case of FIG. 1;

FIG. 3 is a top plan view of the information display case of FIG. 1;

FIG. 4 is a bottom perspective view of a second embodiment of a means for attaching to a shoe;

FIG. 5 is a bottom perspective view of a third embodiment of a means of attaching to a shoe;

FIG. 6 is a bottom perspective view of a fourth embodiment of a means of attaching to a shoe;

FIG. 7 is a bottom perspective view of a fifth embodiment of a means of attaching to a shoe;

FIG. 8 is a side elevation view of the information display case of FIG. 7;

FIG. 9 is a bottom perspective view of a sixth embodiment of a means of attaching to a shoe; and

FIG. 10 is a block diagram of a preferred information display unit of the present invention.

### DETAILED DESCRIPTION OF THE PREFERRED EMBODIMENTS

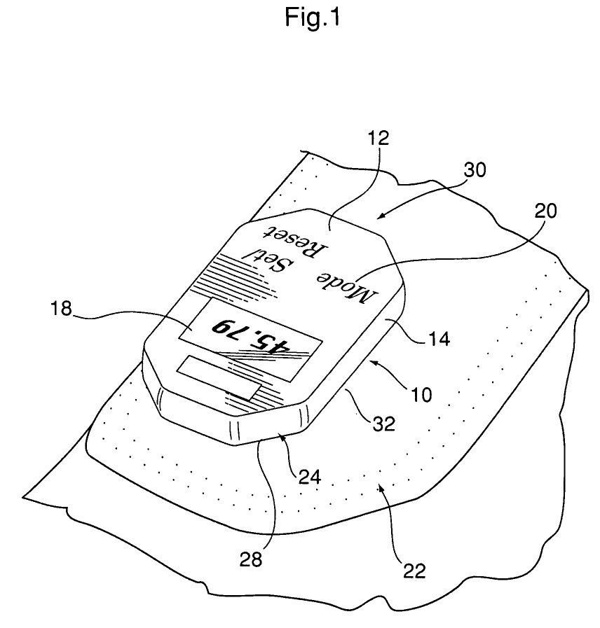

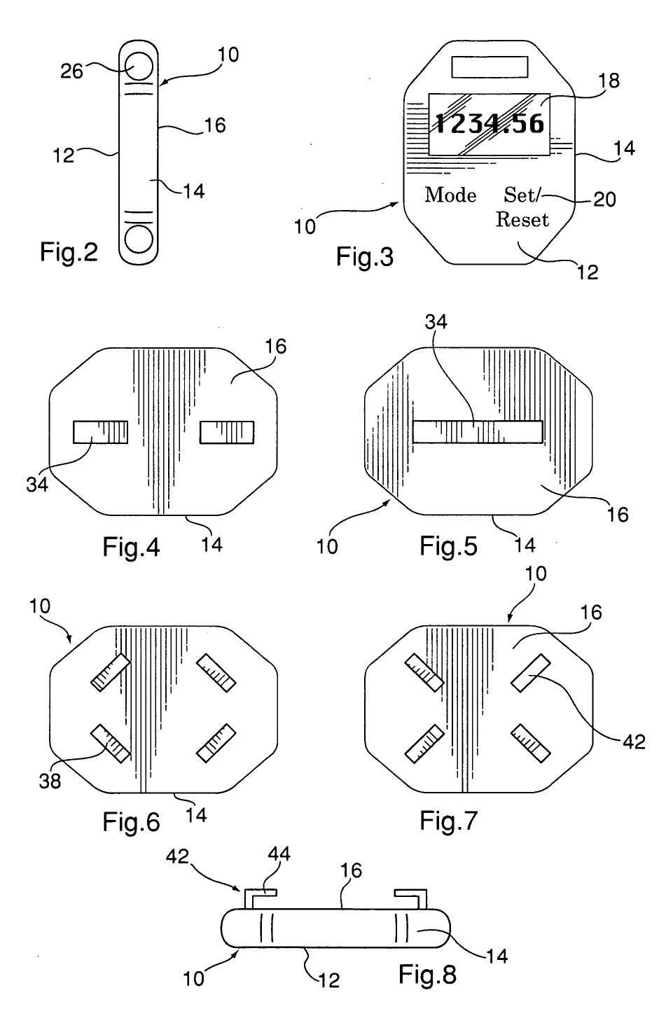

A first preferred embodiment of an information display case of the present invention is illustrated in FIGS. 1 to 3 generally indicated by the numeral 10. The display case 10 has an upper surface 12, side surfaces 14 and a lower surface 16. A display means, preferably an LCD display 18 is provided in the upper surface 12 for displaying the information generated by the information display case as will be explained hereinbelow. Upper surface 12 is also provided with a plurality of buttons 20, to allow the user to program the information display unit and to select the information to be displayed on the LCD display 18.

The side surfaces 14 or lower surface 16 is provided with a means for releasably attaching the information display unit 10 to a shoe 22. In the embodiment illustrated in FIGS. 1 to 3, the means for releasably attaching the information display unit 10 to the shoe 22 is provided by openings 24 at the corners where adjacent side surfaces 14 meet. Opening 24 has a tunnel 26 which passes through the display unit from one side surface 14 to an opposite side surface 14. The shoelaces 28 of the shoe are fed through the tunnels 26, releasably attaching the information display unit 10 to the shoe 22. In this way, the information display unit 10 is held firmly in place above the tongue 30 of the shoe 22.

The information display unit 10 is laced onto a shoe 22 by removing the shoelaces 28 from the eyelets 32 of the shoe 22 except for (but may be if wanted) the most forward pair of eyelets 32. Then, the shoelaces 28 are fed through the tunnel 26 on one end of the information display unit 10 and fed into the adjacent pair of eyelets 32. The information display unit 10 is then flipped forward and another pair of eyelets 32 is laced. Depending on the size of the shoe 22 or the distance between eyelets 32, either another pair of eyelets 32 is laced or the information display unit 10 is flipped back on top of the shoelaces 28 and the shoelaces 28 are fed through the tunnel 26 at the opposite end of the information display unit 10. The information display unit 10 is then securely mounted over the tongue 30 of the shoe 22 and ready to begin calculating.

Alternative means for releasably attaching the information display unit 10 to the shoe 22 are illustrated in FIGS. 4 to 9. As shown in FIGS. 4 and 5, the lower surface 16 of the information display unit 10 may be provided with one or more U shaped protrusions 34 extending lengthwise of the information display unit 10. Each of the U shaped protrusions 34 has an opening 36 through which the shoelaces 28 may pass to secure the information display unit 10 to the shoe 22. This design of the attaching means is particularly useful with shoe designs which employ VELCRO™ straps in place of shoelaces to attach the shoe to the user's foot. In this circumstance, the VELCRO™ straps are placed through the opening 36 of the U shaped protrusions 34 and securely hold the information display unit 10 to the shoe 22.

A further embodiment of the means for releasably attaching the information display unit 10 to the shoe 22 is shown in FIG. 6. This embodiment of the information display unit 10 is provided with a plurality of U shaped protrusions 38 on the lower surface 16. Preferably as shown in FIG. 6, there are four U shaped protrusions 38 located at the corners of lower surface 16 of the information display unit 10 angled at about a 45° angle to the longitudinal axis of the information display unit 10. Each of the U shaped protrusions is provided with an opening 40 through which the shoelaces 28 may pass to secure the information display unit 10 to the shoe 22.

Yet another embodiment of the means of releasably attaching the information display unit 10 to the shoe 22 is shown in FIGS. 7 and 8. This embodiment of the information display unit 10 is provided with a plurality of L brackets 42 extending from the lower surface 16. Preferably, there are four such L brackets 42 located at the corners of the lower surface 16 in the information display unit. Each of the L brackets being angled at about a 45° angle to the longitudinal axis of the information display unit 10. The bite 44 of the L shaped bracket 42 is slipped under and engages the lower surface of the shoe laces 28 to hold the information display unit 10 on the shoe 22. This embodiment may also be used with VELCRO™ attachments with the L brackets 42 engaging the VELCRO straps.

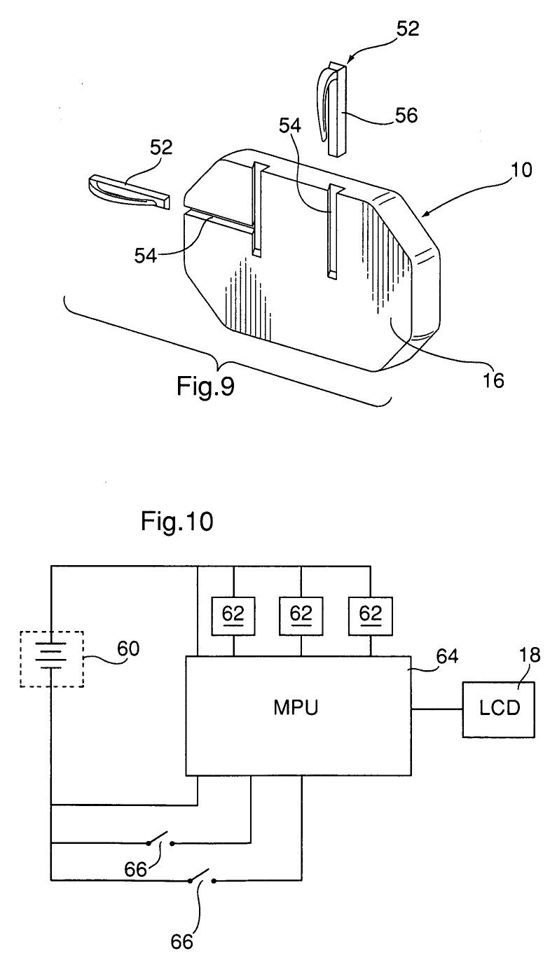

A further embodiment of the means of releasably attaching the information display unit 10 to the shoe 22 is shown in FIG. 9. This embodiment of the information display unit 10 is provided with a plurality of tension clips 52 extending from the lower surface 16. The tension clips 52 may extend either laterally or longitudinally of the lower surface 16. The tension clip 52 is slipped under and engages the lower surface of the shoe laces 28 to hold the information display unit 10 on the shoe 22. This embodiment may also be used with VELCRO™ attachments with the tension clips 52 engaging the VELCRO™ straps. Preferably, the tension clips 52 releasably engage the lower surface 16. This may be accomplished by providing dovetail slots 54 extending in one or both of the longitudinal and lateral direction of the lower surface 16. Tension clips 52 are provided with a matching dovetail lower portion 56 which slidably engages with the dovetail slots 54 in the lower surface. By providing the dovetail slots 54 in both directions, the user has the option of the direction to insert the tension clips 52.

Alternatively, the information display case 10 may be provided with a VELCRO™ strap arrangement to attach the information display case 10 to the shoe 22. VELCRO™ can be attached to the underside of the case with the hooks part visible. The VELCRO™ tape curls under the laces or other means of lacing footwear and back around so that the loops can attach to the hooks forming a secure, removable method of attaching and releasing the display case to most forms of footwear.

The operation of a preferred embodiment of the information display unit of the present invention will now be described with reference to the block diagram set out in FIG. 10. The information display unit 10 contains a power source 60 for the circuitry of the unit 10. Preferably power source 60 is a rechargeable battery and the information display unit 10 may be provided with solar cells to recharge the battery as the unit is being worn. The information display unit is also provided with one or more suitable detectors 62 to detect the information to be calculated and displayed. In the preferred embodiment, detector 62 detects the footfall of the user to allow for the distances covered by the user to be calculated and displayed. Other detectors may also be provided to detect such as for example, temperature, altitude or geographical position. The output from the detector 62 is fed to an input of a microprocessor unit (MPU) 64, which contains the necessary programming to receive the information from the detector and calculate the relevant information. An output of the MPU 64 is connected to the LCD display 18 to allow the relevant information to be displayed on the LCD display 18. For example, if the information display unit 10 is being used as a pedometer, the MPU 64 is programmed with the stride length of the user and by counting the footfalls detected by the detector 62, calculates and displays the distance traveled. The MPU 64 may also calculate and display the average or instantaneous speed of the users travels. Other information will be calculated and displayed based upon the detectors 62 present in the information display unit 10 and the programming of the MPU 64.

To allow the user to program and interact with the MPU 64, a number of input switches 66 are provided accessible from the upper surface 12 of the information display unit 10. Switches 66 allow the user to input information required by the MPU 64 such as for example, the stride length of the user. In information display units 10 allowing for multiple types of information being calculated and available, switches 66 allow the user to select the information to be displayed on the LCD display. Switches 66 also allow the user to reset the unit for a new use or to recall information from previous uses.

The information display unit of the present invention is a self contained unit that makes use of the laces and/or other fasteners of a shoe or a boot to neatly attach the information display unit to the top of the footwear above the footwear's tongue. The information display unit of the present invention allows a user to easily attach and remove the unit from the shoe, allowing the unit to be used with multiple shoes of different types and uses. Being totally self contained, there are no additional parts to be interconnected prior to use.

The information display unit of the present invention can be used for example, to house software and/or hardware to display and gather information pertaining to the wearer's distances traversed or calories burned or the amount of steps taken or speed traversed. It can also display the wearer's altitude attained or to track the location of the wearer using GPS technology and/or can be used to house a communication or a timing device. Even a compass, an alarm and/or incorporating voice technology are just some of the many applications with which the design can be used to display, hear or feel information on footwear products.

The information display unit of the present invention can make use of but is not limited to; plastic, glass, metal, fabric and rubber and can make use of an electronic display technology such as liquid crystal display or audio technology or even vibration technology to let the wearer be aware of virtually any information that can be gathered through the installation of the applicable hardware/software within the information display unit.

Although various preferred embodiments of the present invention have been described herein in detail, it will be appreciated by those skilled in the art that variations may be made thereto without departing from the spirit of the invention or the scope of the appended claims.

What is claimed is:

1. An information display unit comprising a power source and a program for gathering and calculating information located in the interior of the information display unit, a display means on an upper surface of the information display unit for displaying the information, a side or lower surface of the information display unit being provided with a means for releasably attaching the information display unit to a shoe.

2. An information display unit according to claim 1 wherein the means for releasably attaching the display case to a shoe is an opening provided at the corners of the information display unit through which shoelaces of a shoe may pass to releasably attach the information display unit to a shoe.

3. An information display unit according to claim 1 wherein the means for releasably attaching the information display unit to a shoe is one or more U shaped protrusions on the lower surface of the information display unit through which shoelaces or other fastening devices of the shoe may pass to releasably attach the information display unit to a shoe.

4. An information display unit according to claim 1 wherein the means for releasably attaching the information display unit to a shoe is one or more tension clips on the lower surface of the information display unit which engage shoelaces or other fastening devices of the shoe to releasably attach the information display unit to a shoe.

5. An information display unit according to claim 1 wherein, the information gathered and calculated by the program and displayed on the display means includes one or more of the distance traversed, calories burned, the amount of steps taken, speed traverse, altitude attained or geographical location.

6. An information display unit according to claim 1 wherein the display means is one or more of a visual display means or an audible display means.

7. An information display unit according to claim 6 wherein the display means is a liquid crystal visual display.

8. An information display unit according to claim 1 which includes as a power source, a battery or solar energy cell.
